(19) United States
(12) Patent Application Publication
(10) Pub. No.: US 2018/0268867 A1
(43) Pub. Date: Sep. 20, 2018

(54) VIDEO PROCESSING APPARATUS, VIDEO PROCESSING METHOD AND STORAGE MEDIUM FOR PROPERLY PROCESSING VIDEOS

(71) Applicant: CASIO COMPUTER CO., LTD., Tokyo (JP)

(72) Inventor: Kosuke MATSUMOTO, Tokyo (JP)

(73) Assignee: CASIO COMPUTER CO., LTD., Tokyo (JP)

(21) Appl. No.: 15/883,007

(22) Filed: Jan. 29, 2018

(30) Foreign Application Priority Data
Mar. 16, 2017 (JP) 2017-050780

(51) Int. Cl. G11B 27/031; G11B 27/30; G06K 9/00

(52) U.S. Cl. CPC G11B 27/031; G06K 9/00718; G06K 9/00335; G11B 27/3081

(57) ABSTRACT

A video processing apparatus includes a target-of-interest identification section and a processing section. The target-of-interest identification section identifies targets of interest from a video. The targets of interest are contained in the video, and at least one of the targets of interest is a person. The processing section performs a predetermined process according to an association element. The association element associates, in the video, the identified targets of interest with one another.

### CROSS-REFERENCE TO RELATED APPLICATIONS

This application is based upon and claims the benefit of priority from the prior Japanese Patent Application No. 2017-050780, filed on Mar. 16, 2017, the entire contents of which are incorporated herein by reference.

### BACKGROUND OF THE INVENTION

### 1. Field of the Invention

The present invention relates to a video processing apparatus, a video processing method and a storage medium for properly processing videos.

### 2. Description of the Related Art

There has been a problem that, unlike still images, when videos are reproduced, they lack interest because videos tend to be monotonous even if ordinary people take videos with an intention to make them interesting. In order to solve this problem, for example, there is described in Japanese Patent Application Publication No. 2009-288446 a technique of estimating expression of a listener(s) from a karaoke video in which a singer and the listener are captured, and combining the original karaoke video with a text(s) and/or an image(s) according to the expression of the listener.

### SUMMARY OF THE INVENTION

According to a first aspect of the present invention, there is provided a video processing apparatus including: a target-of-interest identification section that identifies, from a video, targets of interest which are contained in the video, wherein at least one of the targets of interest is a person; and a processing section that performs a predetermined process according to an association element that associates the targets of interest in the video with one another, the targets of interest being identified by the target-of-interest identification section.

According to a second aspect of the present invention, there is provided a video processing apparatus including: a person's change detection section that detects, from a video to be edited, a change in a condition of a person recorded in the video; and an editing section that, when the person's change detection section detects a predetermined change in the condition of the person, edits the video in terms of time according to a factor in the predetermined change in the video.

According to a third aspect of the present invention, there is provided a video processing method including: identifying, from a video, targets of interest which are contained in the video, wherein at least one of the targets of interest is a person; and performing a predetermined process according to an association element that associates the targets of interest in the video with one another, the targets of interest being identified in the identifying.

According to a fourth aspect of the present invention, there is provided a video processing method including: detecting, from a video to be edited, a change in a condition of a person recorded in the video; and when, in the detecting, detecting a predetermined change in the condition of the person, editing the video in terms of time according to a factor in the predetermined change in the video.

According to a fifth aspect of the present invention, there is provided a non-transitory computer readable storage medium storing a program that causes a computer to realize: a target-of-interest identification function that identifies, from a video, targets of interest which are contained in the video, wherein at least one of the targets of interest is a person; and a processing function that performs a predetermined process according to an association element that associates the targets of interest in the video with one another, the targets of interest being identified by the target-of-interest identification function.

According to a sixth aspect of the present invention, there is provided a non-transitory computer readable storage medium storing a program that causes a computer to realize: a person's change detection function that detects, from a video to be edited, a change in a condition of a person recorded in the video; and an editing function that, when the person's change detection function detects a predetermined change in the condition of the person, edits the video in terms of time according to a factor in the predetermined change in the video.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF DRAWING

The accompanying drawings, which are incorporated in and constitute a part of the specification, illustrate embodiments of the invention, and together with the general description given above and the detailed description of the embodiments given below, serve to explain the principles of the invention, wherein:

FIG. 1 schematically shows configuration of a video processing apparatus according to a first embodiment of the present invention;

FIG. 2A shows an example of an association table according to the first embodiment;

FIG. 2B shows an example of an edit content table according to the first embodiment;

FIG. 3 is a flowchart showing examples of actions of video editing according to the first embodiment;

FIG. 4 schematically shows configuration of a video processing apparatus according to a second embodiment of the present invention;

FIG. 5 shows an example of an association table according to the second embodiment;

FIG. 6 is a flowchart showing examples of actions of video processing according to the second embodiment;

FIG. 7 schematically shows configuration of a video processing apparatus according to a third embodiment of the present invention;

FIG. 8 shows an example of a factor identification table according to the third embodiment;

FIG. 9 shows an example of an edit content table according to the third embodiment; and

FIG. 10 is a flowchart showing examples of actions of video editing according to the third embodiment.

### DETAILED DESCRIPTION OF THE INVENTION

Hereinafter, specific embodiments of the present invention are described with reference to the drawing. However, the scope of the present invention is not limited to the illustrated embodiments or examples.

### First Embodiment

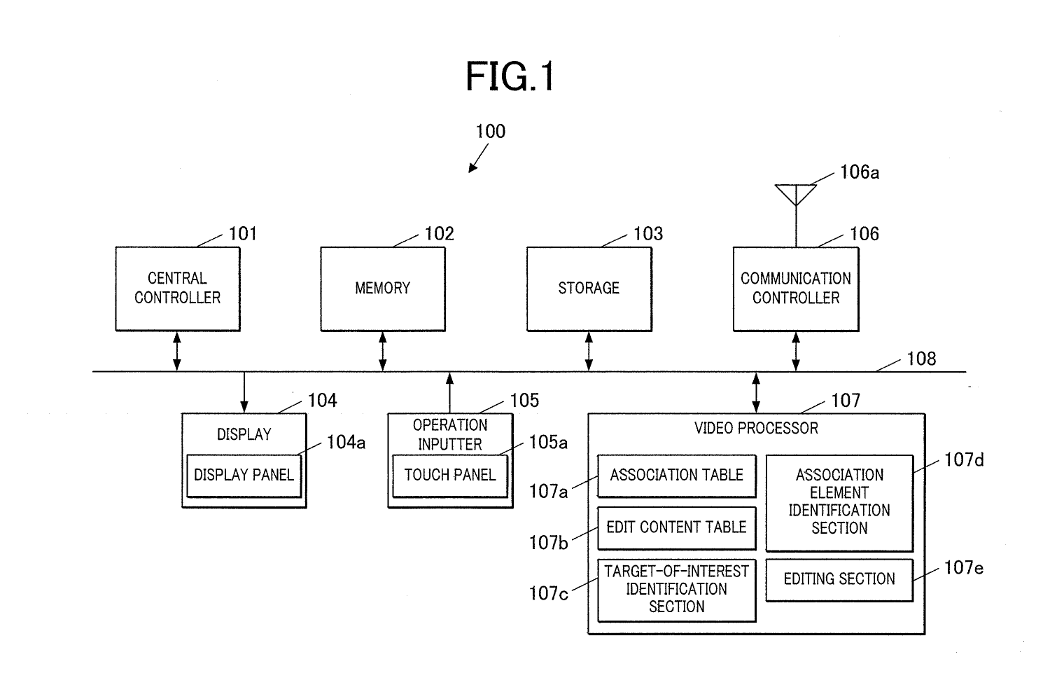

FIG. 1 is a block diagram schematically showing configuration of a video processing apparatus 100 according to a first embodiment of the present invention.

As shown in FIG. 1, the video processing apparatus 100 of this embodiment includes a central controller 101, a memory 102, a storage 103, a display 104, an operation inputter 105, a communication controller 106 and a video processor 107.

The central controller 101, the memory 102, the storage 103, the display 104, the operation inputter 105, the communication controller 106 and the video processor 107 are connected to one another via a bus line 108.

The central controller 101 controls the components of the video processing apparatus 100. More specifically, the central controller 101 includes a not-shown CPU (Central Processing Unit), and performs various control actions by following not-shown various process programs for the video processing apparatus 100.

The memory 102 is constituted of, for example, a DRAM (Dynamic Random Access Memory), and temporarily stores therein data or the like that are processed by the central controller 101, the video processor 107 or the like.

The storage 103 is constituted of, for example, an SSD (Solid State Drive), and stores therein image data of still images and videos encoded in a predetermined compression format (e.g. JPEG format, MPEG format, etc.) by a not-shown image processor. The storage 103 may be configured to control reading/writing of data from/in a not-shown storage medium that is freely attached/detached to/from the storage 103. The storage 103 may contain a storage region for a predetermined server apparatus in the state of being connected to a network through the below-described communication controller 106.

The display 104 displays images in a display region of a display panel 104a.

That is, the display 104 displays videos or still images in the display region of the display panel 104a on the basis of image data having a predetermined size decoded by the not-shown image processor.

The display panel 104a is constituted of, for example, a liquid crystal display panel, an organic EL (Electro-Luminescence) display panel or the like, but not limited thereto.

The operation inputter 105 is to input predetermined operations to the video processing apparatus 100. More specifically, the operation inputter 105 includes a not-shown power button for ON/OFF operation of a power supply and not-shown buttons for selection/commanding of various modes, functions and so forth.

When a user operates one of the buttons, the operation inputter 105 outputs an operation command corresponding to the operated button to the central controller 101. The central controller 101 causes the components of the video processing apparatus 100 to perform predetermined actions (e.g. video editing) by following the operation command output and input from the operation inputter 105.

The operation inputter 105 has a touch panel 105a integrated with the display panel 104a of the display 104.

The communication controller 106 sends/receives data through a communication antenna 106a and a communication network.

The video processor 107 includes an association table 107a, an edit content table 107b, a target-of-interest identification section 107c, an association element identification section 107d and an editing section 107e.

Each component of the video processor 107 is constituted of a predetermined logic circuit, but not limited thereto.

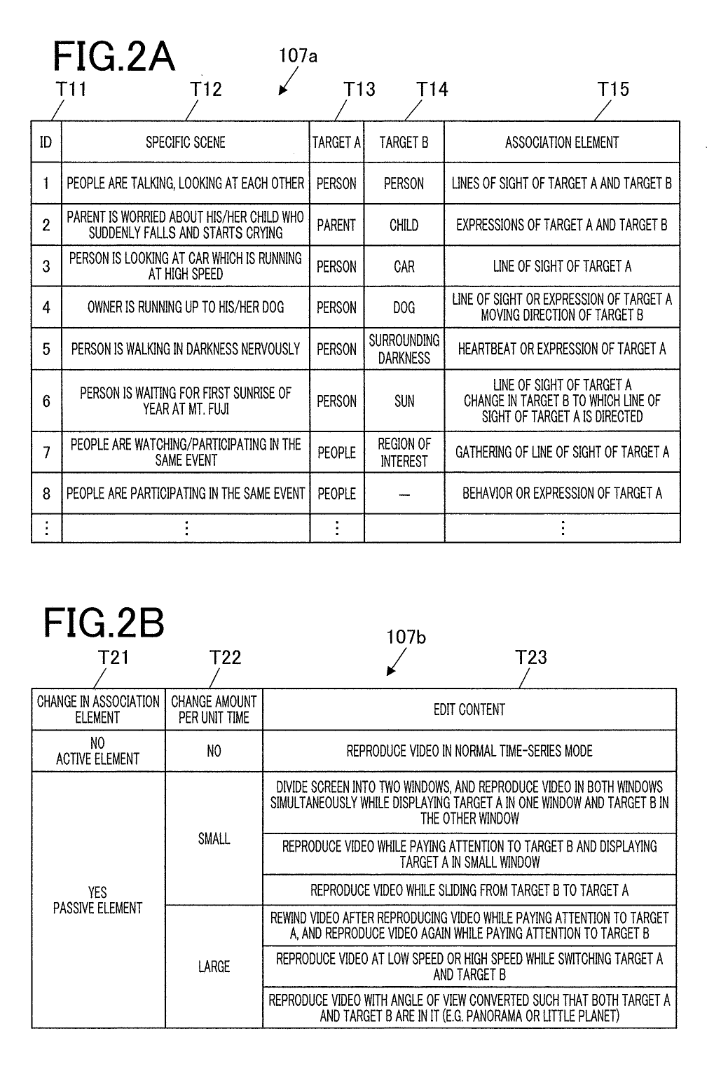

As shown in FIG. 2A, the association table 107a has items “ID” T11 to identify an association element, “Specific Scene” T12 indicating a specific scene, “Target A” T13 indicating one target, “Target B” T14 indicating another target, and “Association Element” T15 indicating the association element.

As shown in FIG. 2B, the edit content table 107b has items “Change in Association Element” T21 indicating whether there is change in the identified association element, “Change Amount per Unit Time” T22 indicating a change amount per unit time, and “Edit Content” T23 indicating edit content (i.e. how to edit videos).

The target-of-interest identification section 107c identifies, from the video (e.g. an omnidirectional (full 360-degree) video) to be edited (hereinafter may be called the “editing video”), targets of interest contained in the video, wherein at least one of the targets of interest is a person.

More specifically, the target-of-interest identification section 107c performs object detection, analysis of a condition of the person(s) (e.g. line-of-sight analysis, heartbeat analysis, expression analysis, etc.) and analysis of a characteristic amount(s) (estimation of a region(s) of interest) on each frame image of the editing video in order so as to identify a target A and a target B which are the targets of interest contained in the frame image and at least one of which is the person.

The association element identification section 107d identifies, in the editing video, the association element(s) that associates the targets of interest with one another, the targets of interest being identified by the target-of-interest identification section 107c. The association element(s) changes with time in the editing video.

More specifically, if the target-of-interest identification section 107c identifies the target A and the target B in one frame image of the editing video, the association element identification section 107d identifies, with the association table 107a, the association element of the ID into which the target A and the target B fall.

For example, if the target-of-interest identification section 107c identifies a parent as the target A and a child as the target B, the association element identification section 107d identifies, with the association table 107a, the association element “Expressions of Target A and Target B” of the ID number “2” under which “Parent” is in the item “Target A” T13 and “Child” is in the item “Target B” T14.

The editing section (a processing section, a determination section) 107e edits the video according to change in the association element in the video, the association element being identified by the association element identification section 107d.

More specifically, the editing section 107e determines whether there is change in the association element in the video, the association element being identified by the association element identification section 107d. Determination as to whether there is change in the association element in the video is made, for example, by determining whether the change amount per unit time is at least a first predetermined threshold value on the basis of a predetermined number of frame images including the frame image in which the association element is identified by the association element identification section 107d.

When determining that the change amount per unit time of the association element in the video identified by the association element identification section 107d is less than the first predetermined threshold value and hence there is no change with time in the association element, namely, there is an active element, the editing section 107e identifies the edit content “Reproduce video in normal time-series mode” with the edit content table 107b, and performs reproduction in a normal time-series mode (editing) on the predetermined number of frame images based on which the determination has been made.

For example, if the association element identification section 107d identifies the association element “Expressions of Target A (parent) and Target B (child)” of the ID number “2” and the editing section 107e determines that there is no change in expressions of the target A (parent) and the target B (child), the editing section 107e performs reproduction in the normal time-series mode (editing).

On the other hand, when determining that the change amount per unit time of the association element in the video identified by the association element identification section 107d is at least the first predetermined threshold value and hence there is the change with time in the association element, namely, there is a passive element, the editing section 107e further determines, in order to determine whether the change is large or small, whether the change amount per unit time of the change is at least a second predetermined threshold value that is for determining the size of the change.

When determining that the change amount per unit time of the change is less than the second predetermined threshold value, namely, small, the editing section 107e identifies, with the edit content table 107b, one type of edit content among three types of “Divide screen into two windows, and reproduce video in both windows simultaneously while displaying target A in one window and target B in the other window”, “Reproduce video while paying attention to target B and displaying target A in small window” and “Reproduce video while sliding from target B to target A”, and performs editing with the identified edit content on the predetermined number of frame images based on which the determination has been made. How to identify one type of edit content among the above three types may be, for example, depending on the change amount per unit time of the association element or at random.

On the other hand, when determining that the change amount per unit time of the change is at least the second predetermined threshold value, namely, large, the editing section 107e identifies, with the edit content table 107b, one type of edit content among three types of “Rewind video after reproducing video while paying attention to target A, and reproduce video again while paying attention to target B”, “Reproduce video at low speed or high speed while switching target A and target B” and “Reproduce video with angle of view converted such that both target A and target B are in it (e.g. panorama editing or little planet editing (360° panorama editing))”, and performs editing with the identified edit content on the predetermined number of frame images based on which the determination has been made. For example, if the association element identification section 107d identities the association element “Expressions of Target A (parent) and Target B (child)” of the ID number “2” and the editing section 107e determines that change in expressions of the target A (parent) and the target B (child) is large, and identifies the edit content “Rewind video after reproducing video while paying attention to target A, and reproduce video again while paying attention to target B”, the editing section 107e performs a process (editing) of rewinding the video after reproducing the video while paying attention to the parent as the target A, and reproducing the video again while paying attention to the child as the target B. How to identify one type of the edit content among the above three types may be, for example, depending on the change amount per unit time of the association element or at random.

### <Video Editing>

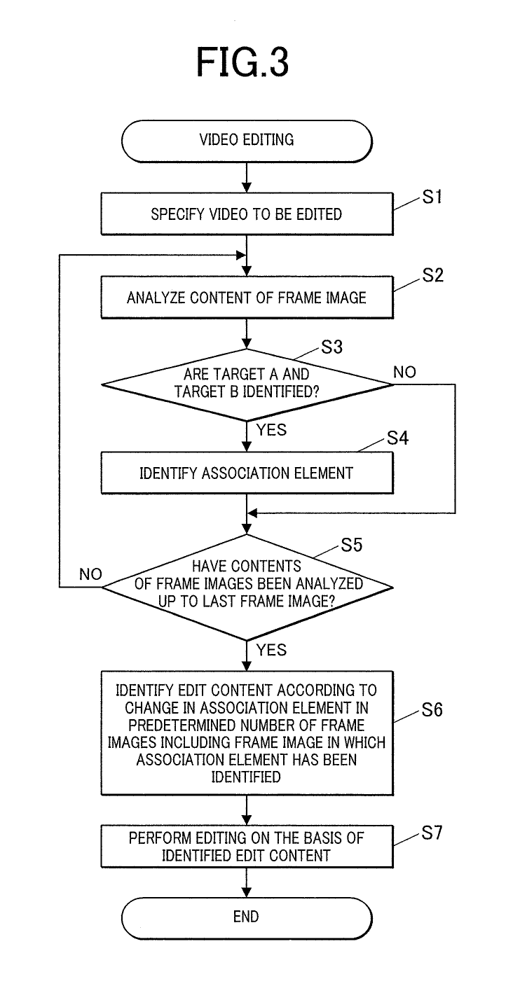

Next, video editing that is performed by the video processing apparatus 100 is described with reference to FIG. 3. FIG. 3 is a flowchart showing examples of actions of the video editing. The functions described in the flowchart are stored in the form of computer readable program code, and the actions are performed by following the program code. Alternatively, with the communication controller 106, the actions may be performed by following computer readable program code transmitted through a transmission medium, such as a network. That is, the actions special to this embodiment can be performed by making use of programs/data supplied from the outside through the transmission medium, if not stored in the storage medium.

As shown in FIG. 3, first, when, on the basis of a user operation, a specifying operation is performed to specify the editing video from videos stored in the storage 103, and a command of the specifying operation is input from the operation inputter 105 to the video processor 107 (Step S1), the video processor 107 reads the specified video from the storage 103, and the target-of-interest identification section 107c performs object detection, analysis of the condition of the person(s) (e.g. line-of-sight analysis, heartbeat analysis, expression analysis, etc.) and analysis of the characteristic amount(s) (estimation of the regions) of interest) on the frame image of the editing video as analysis of content of the frame image (Step S2).

Next, the association element identification section 107d determines whether the target-of-interest identification section 107c identifies the target A and the target B which are the targets of interest contained in the frame image and at least one of which is the person (Step S3).

When determining that the target-of-interest identification section 107c identifies the target A and the target B (Step S3; YES), the association element identification section 107d identifies, with the association table 107a, the association element of an ID number into which the identified target A and target B fall (Step S4), and then advances the process to Step S5.

On the other hand, when determining that the target-of-interest identification section 107c does not identify the target A and the target B (Step S3; NO), the association element identification section 107d skips Step S4 and advances the process to Step S5.

Next, the video processor 107 determines whether the target-of-interest identification section 107c has analyzed the contents of the frame images of the video up to the last frame image (Step S5).

When determining that the target-of-interest identification section 107c has not analyzed the contents of the frame images of the video up to the last frame image yet (Step S5; NO), the video processor 107 returns the process to Step S2 to repeat the step and the following steps.

On the other hand, when the video processor 107 determines that the target-of-interest identification section 107c has analyzed the contents of the frame images of the video up to the last frame image (Step S5; YES), the editing section 107e identifies the edit content according to change in the association element(s), identified in Step S4, in the predetermined number of frame images including the frame image in which the association element has been identified (Step S6).

Then, on the basis of the edit content identified in Step S6, the editing section 107e performs editing on the predetermined number of frame images including the frame image in which the association element has been identified (Step S7), and then ends the video editing.

As described above, the video processing apparatus 100 of this embodiment identifies, from the video, the targets of interest which are contained in the video and at least one of which is the person. Further, the video processing apparatus 100 performs a predetermined process according to the association element that associates the identified targets of interest in the video with one another. Alternatively, the video processing apparatus 100 identifies, in the video, the association element that associates the identified targets of interest with one another, and performs the predetermined process according to the identified association element.

This makes it possible, when performing the predetermined process on the video, to pay attention to the association element that associates the targets of interest with one another, at least one of which is the person. Thus, this can properly process the video according to the person as the target of interest contained in the video.

Further, the video processing apparatus 100 of this embodiment identifies, in the video, the association element that associates the targets of interest with one another and changes with time, and performs the predetermined process according to the change with time in the identified association element in the video. This makes it possible, when performing the predetermined process on the video, to properly perform the process in relation to the targets of interest.

Further, the video processing apparatus 100 of this embodiment edits the video according to the change with time in the identified association element in the video, thereby performing the predetermined process. This can edit the video(s) effectively.

Further, the video processing apparatus 100 of this embodiment determines the change amount of the identified association element in the video, and edits the video according to the determination result, thereby performing the predetermined process. This can edit the video(s) more effectively.

Further, the video processing apparatus 100 of this embodiment identifies the targets of interest based on at least two of object detection, analysis of the condition of the person, and analysis of the characteristic amount(s) in the video. This can identify the targets of interest with high accuracy.

Further the video processing apparatus 100 of this embodiment identifies at least one of heartbeat, expression, behavior and line of sight of the person as the association element. This makes it possible, when processing the video, to more properly perform the process in relation to the targets of interest, at least one of which is the person.

### Second Embodiment

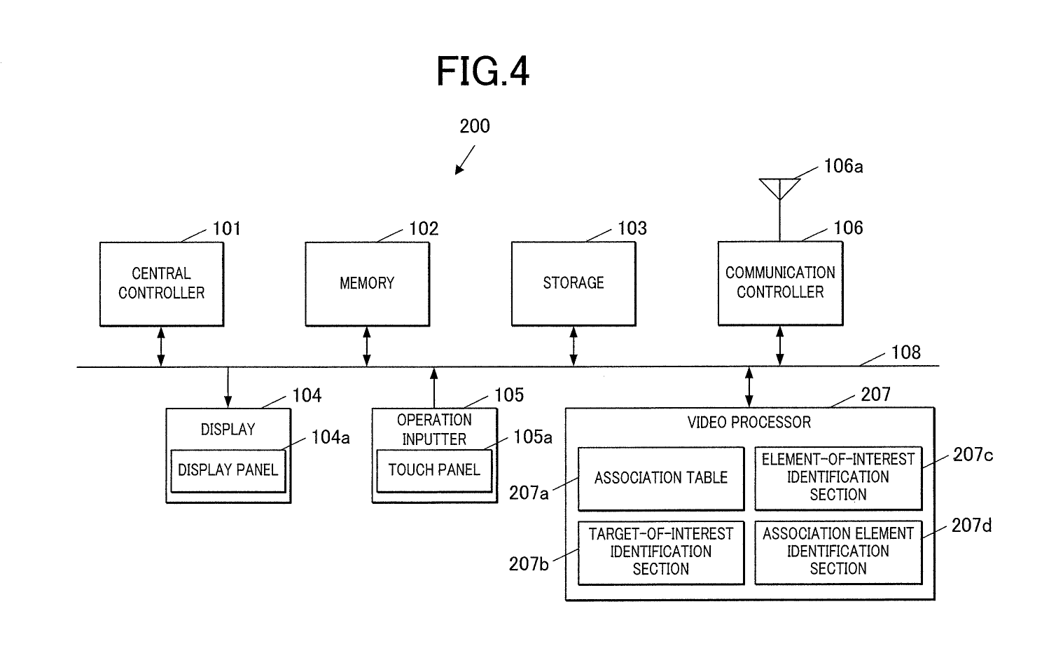

Next, a video processing apparatus 200 according to a second embodiment is described with reference to FIG. 4 to FIG. 6. The same components as those in the first embodiment are provided with the same reference numbers as those in the first embodiment, and descriptions thereof are not repeated here.

The video processing apparatus 200 of this embodiment identifies, on the basis of a real-time video, targets of interest (the target A and the target B) and elements of interest of the respective targets of interest, each of the elements changing with time, and identifies an association element(s) that associates the targets of interest with one another on the basis of the identified elements of interest of the respective targets of interest.

As shown in FIG. 4, a video processor 207 of this embodiment includes an association table 207a, a target-of-interest identification section 207b, an element-of-interest identification section 207c and an association element identification section 207d.

Each component of the video processor 207 is constituted of a predetermined logic circuit, but not limited thereto.

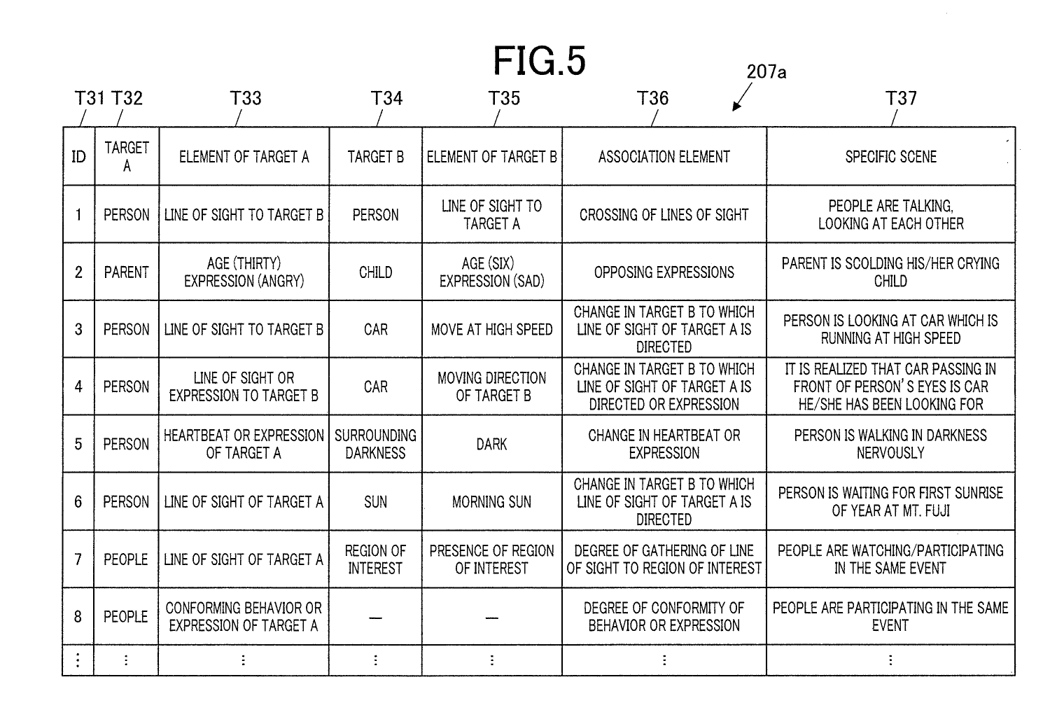

As shown in FIG. 5, the association table 207a has items “ID” T31 to identify the association element, “Target A” T32 indicating one target, “Element of Target A” T33 indicating an element of interest of the target A, “Target B” T34 indicating another target, “Element of Target B” T35 indicating an element of interest of the target B, “Association Element” T36 indicating the association element, and “Specific Scene” T37 indicating a specific scene.

The target-of-interest identification section 207b identifies, from the real-time video (e.g. an omnidirectional (full 360-degree) video), the targets of interest contained in the video, wherein at least one of the targets of interest is a person.

More specifically, the target-of-interest identification section 207b performs object detection, analysis of a condition of the person(s) (e.g. line-of-sight analysis, heartbeat analysis, expression analysis, etc.) and analysis of a characteristic amount(s) (estimation of a region(s) of interest) on each frame image of the video successively taken by a live camera (imager) and obtained through the communication controller 106 so as to identify the target A and the target B which are the targets of interest contained in the frame image and at least one of which is the person.

The element-of-interest identification section 207c identifies the elements of interest of the respective targets of interest identified from the real-time video by the target-of-interest identification section 207b, wherein each of the elements changes with time in the real-time video.

More specifically, if the target-of-interest identification section 207b identifies the target A and the target B in one frame image of the real-time video, the element-of-interest identification section 207c identifies, with the association table 207a, the element of interest of the target A (element of the target A) and the element of interest of the target B (element of the target B) on the basis of the results of object detection, analysis of the condition of the person(s) and analysis of the characteristic amount(s).

The association element identification section 207d identifies the association element that associates the identified targets of interest in the real-time video with one another on the basis of the elements of interest of the respective targets of interest, the elements being identified by the element-of-interest identification section 207c.

More specifically, if the target-of-interest identification section 207b identifies the target A and the target B in one frame image of the real-time video, and the element-of-interest identification section 207c identifies the elements of interest of the target A and the target B, the association element identification section 207d identifies, with the association table 207a, the association element of an ID into which the identified elements of interest of the target A and the target B fall.

For example, if the element-of-interest identification section 207c identifies “Line of Sight or Expression to Target B” as the element of interest of the target A that is the person, and “Moving Direction of Target B” as the element of interest of the target B that is a car, the association element identification section 207d identifies, with reference to the association table 207a, the association element “Change in Target B to Which Line of Sight of Target A is Directed or Expression” of the ID number “4” under which “Line of Sight or Expression to Target B” is in the item “Element of Target A” T33 and “Moving Direction of Target B” is in the item “Element of Target B” T35.

### <Video Processing>

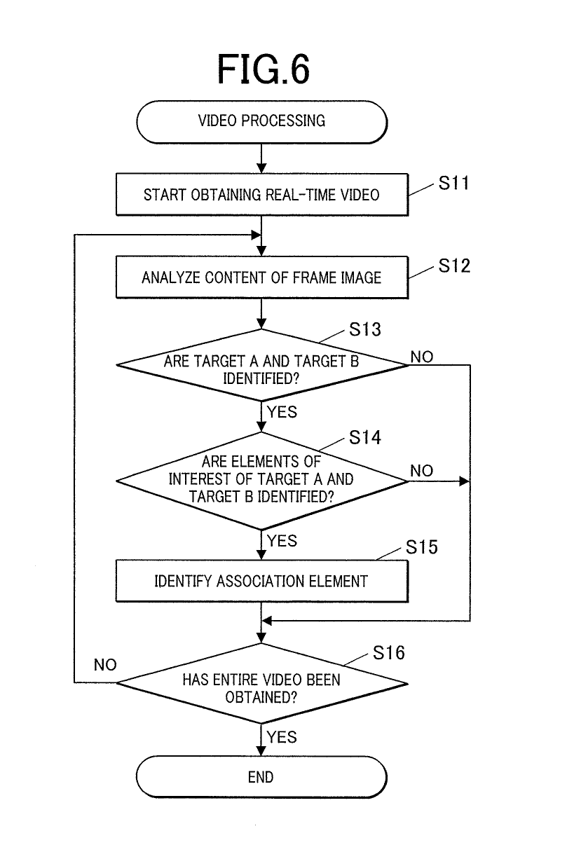

Next, video processing that is performed by the video processing apparatus 200 is described with reference to FIG. 6. FIG. 6 is a flowchart showing examples of actions of the video processing.

As shown in FIG. 6, first, when, on the basis of a user operation, an operation is performed to start obtaining the real-time video to be subjected to the video processing, and a command of the operation is input from the operation inputter 105 to the video processor 207, the video processor 207 starts obtaining the real-time video through the communication controller 106 (Step S11).

Next, the target-of-interest identification section 207b performs object detection, analysis of the condition of the person(s) (e.g. line-of-sight analysis, heartbeat analysis, expression analysis, etc.) and analysis of the characteristic amount(s) (estimation of the region(s) of interest) on the obtained frame image of the video as analysis of content of the frame image (Step S12).

Next, the association element identification section 207d determines whether the target-of-interest identification section 207b identifies the target A and the target B which are targets of interest contained in the frame image and at least one of which is the person (Step S13).

When determining that the target-of-interest identification section 207b identifies the target A and the target B (Step S13; YES), the association element identification section 207d determines whether the element-of-interest identification section 207c identifies the elements of interest of the target A and the target B (Step S14).

When determining that the element-of-interest identification section 207c identifies the elements of interest of the target A and the target B (Step S14; YES), the association element identification section 207d identifies, with the association table 207a, the association element of an ID number into which the identified elements of interest of the target A and the target B fall (Step S15), and then advances the process to Step S16.

On the other hand, when determining that the target-of-interest identification section 207b does not identify the target A and the target B (Step S13; NO), or when determining that the element-of-interest identification section 207c does not identify the elements of interest of the target A and the target B (Step S14; NO), the association element identification section 207d advances the process to Step S16.

Next, the video processor 207 determines whether the entire real-time video has been obtained (Step S16).

When determining that the entire real-time video has not been obtained yet (Step S16; NO), the video processor 207 returns the process to Step S12 to repeat the step and the following steps.

On the other hand, when determining that the entire real-time video has been obtained (Step S16; YES), the video processor 207 ends the video processing.

As described above, the video processing apparatus 200 of this embodiment identifies, from the real-time video, the targets of interest which are contained in the video and at least one of which is the person. Further, the video processing apparatus 200 performs the process in relation to the identified targets of interest according to the association element that associates the targets of interest in the video with one another. Alternatively, the video processing apparatus 200 identifies, in the video, the association element that associates the identified targets of interest with one another, and performs the process in relation to the targets of interest according to the identified association element.

This makes it possible to pay attention to the association element that associates targets of interest with one another. Thus, this can, when processing the real-time video, properly perform the process in relation to the targets of interest, at least one of which is the person.

Further, the video processing apparatus 200 of this embodiment identifies elements of interest of the identified targets of interest, each of the elements of interest changing with time in the video, and based on the respective identified elements of interest of the respective targets of interest, identifies, in the video, the association element that associates the targets of interest with one another. This can identify the association element(s) with high accuracy.

Further, the video processing apparatus 200 of this embodiment identifies the targets of interest based on at least two of object detection, analysis of the condition of the person, and analysis of the characteristic amount(s) in the video. This can identify targets of interest with high accuracy.

Further, the video processing apparatus 200 of this embodiment identifies at least one of heartbeat, expression, behavior and line of sight of the person as the association element. This makes it possible, when processing the video, to more properly perform the process in relation to targets of interest, at least one of which is the person.

### Third Embodiment

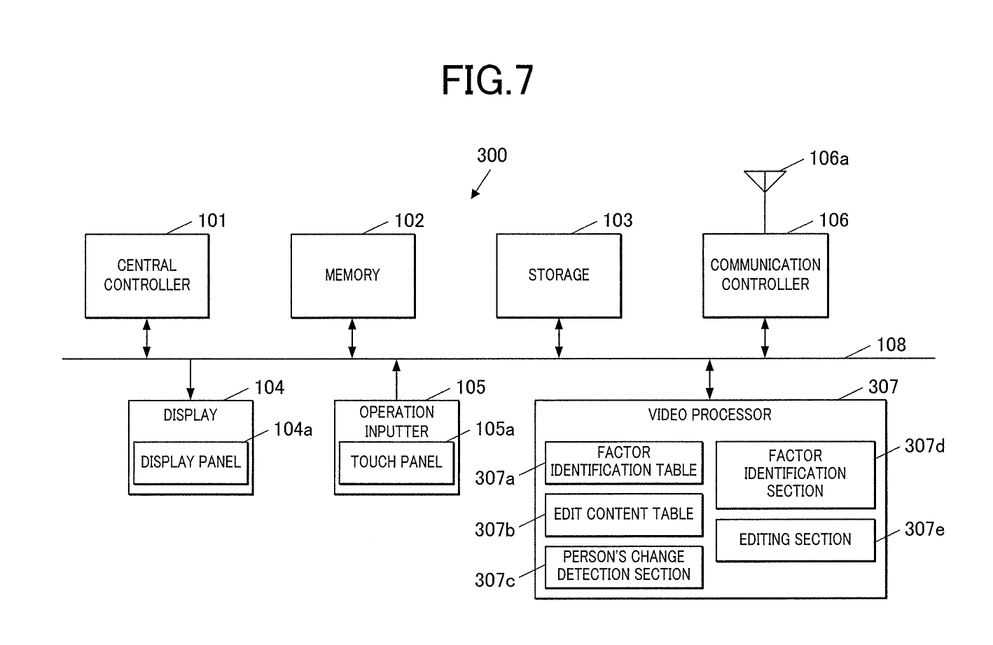

Next, a video processing apparatus 300 according to a third embodiment is described with reference to FIG. 7 to FIG. 10. The same components as those in the first and second embodiments are provided with the same reference numbers as those in the first and second embodiments, and descriptions thereof are not repeated here.

The video processing apparatus 300 of this embodiment identifies, when detecting a predetermined change in a condition of a person recorded in an editing video, a factor in the predetermined change and edits the video according to the identified factor.

As shown in FIG. 7, a video processor 307 of this embodiment includes a factor identification table 307a, an edit content table 307b, a person's change detection section 307c, a factor identification section 307d and an editing section 307e.

Each component of the video processor 307 is constituted of a predetermined logic circuit, but not limited thereto.

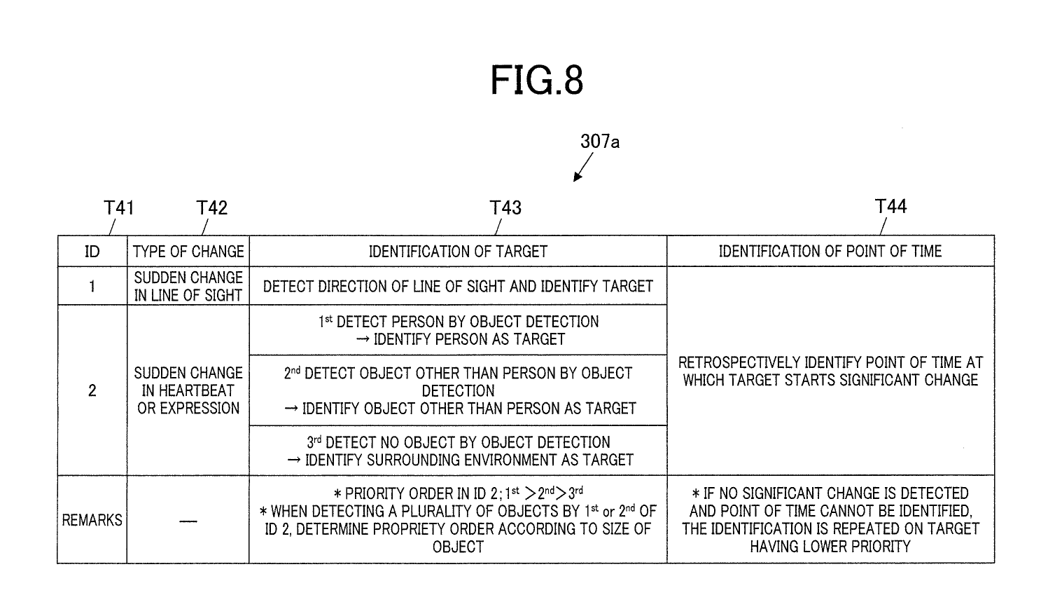

As shown in FIG. 8, the factor identification table 307a has items “ID” T41 to identify a factor identification method for identifying a factor, “Type of Change” T42 indicating a type of change in the condition of the person, “Identification of Target” T43 indicating a target identification method for identifying a target, and “Identification of Point of Time” T44 indicating a point-of-time identification method for identifying a point of time of the identified target.

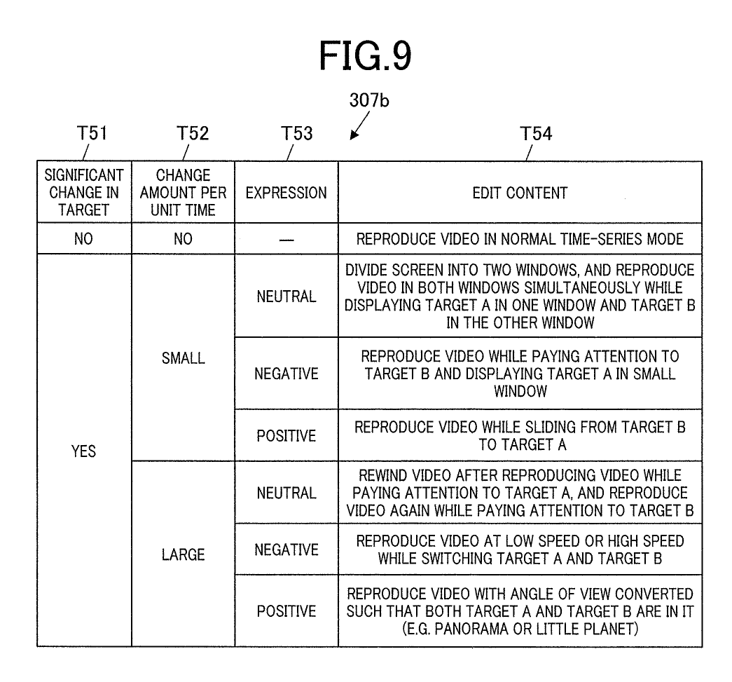

As shown in FIG. 9, the edit content table 307b has items “Significant Change in Target” T51 indicating whether there is a significant change in the identified target, “Change Amount per Unit Time” T52 indicating a change amount per unit time, “Expression” T53 indicating a type of expression, and “Edit Content” T54 indicating edit content.

The person's change detection section 307c detects, from the editing video (e.g. an omnidirectional (full 360-degree) video), change in the condition of the person recorded in the video.

More specifically, the person's change detection section 307c performs object detection, analysis of the condition of the person(s) (e.g. line-of-sight analysis, heartbeat analysis, expression analysis, etc.) and analysis of a characteristic amount(s) (estimation of a region(s) of interest) so as to detect, from the editing video, change in the condition of the person recorded in the video.

For example, if a scene where a parent with a smile suddenly changes his/her expression to a worried expression owing to a fall of his/her child is recorded in the editing video, the person's change detection section 307c detects the change in the expression of the parent (person).

The factor identification section (an identification section, a target identification section, a point-of-time identification section, a target's change detection section) 307d identifies, when the person's change detection section 307c detects a predetermined change in the condition of the person in the editing video, a factor in the predetermined change in the editing video.

More specifically, each time the person's change detection section 307c detects change in the condition of the person recorded in the video, the factor identification section 307d determines, with the factor identification table 307a, whether the detected change in the condition of the person falls into one of “Sudden Change in Line of Sight” of the ID number “1” and “Sudden Change in Heartbeat or Expression” of the ID number “2”.

For example, in the above case, when the person's change detection section 307c detects change in expression of the parent (person), the factor identification section 307d determines that the detected change in the condition of the person falls into “Sudden Change in Heartbeat or Expression” of the ID number “2”.

When determining that the change in the condition of the person detected by the person's change detection section 307c falls into one of “Sudden Change in Line of Sight” of the ID number “1” and “Sudden Change in Heartbeat or Expression” of the ID number “2”, the factor identification section 307d identifies the target by the target identification method(s) indicated in the item “Identification of Target” T43 of the ID number into which the detected change falls. More specifically, when determining that the detected change in the condition of the person falls into “Sudden Change in Line of Sight” of the ID number “1”, the factor identification section 307d identifies, as the target, an object to which the person's line of sight is directed in the frame image in which the predetermined change in the condition of the person has been detected by the person's change detection section 307c. Meanwhile, when determining that the detected change in the condition of the person falls into “Sudden Change in Heartbeat or Expression” of the ID number “2”, the factor identification section 307d identifies the target on the basis of the state of the characteristic amount in the frame image in which the predetermined change in the condition of the person has been detected by the person's change detection section 307c.

Further, the factor identification section 307d retrospectively identifies the point of time at which the target starts a significant change by the point-of-time identification method indicated in the item “Identification of Point of Time” T44.

If the factor identification section 307d identifies, as the target, the object to which the person's line of sight is directed in the frame image in which the predetermined change in the condition of the person has been detected by the person's change detection section 307c, and the change amount per unit time of the object to which the person's line of sight is directed exceeds a first predetermined threshold value, it means that there is the significant change in the target. Here, the change amount per unit time is obtained by tracing the object back in terms of time. For example, there is a significant time in the target, in the case where the object (target) is the person, if he/she has been running and suddenly falls, or has not been moving but suddenly starts running, and in the case where the object (target) is a thing, if the thing on a desk starts falling. If the factor identification section 307d identifies the target on the basis of the state of the characteristic amount in the frame image in which the predetermined change in the condition of the person has been detected by the person's change detection section 307c, and the change amount per unit time of the characteristic amount in the frame image exceeds the first predetermined threshold value, it means that there is the significant change in the target. Here, the change amount per unit time is obtained by tracing the whole of the frame image back in terms of time. For example, there is the significant change in the target if a movable object, such as a car, enters at high speed, or, like sunrise or sunset, color in the frame images suddenly starts changing.

For example, in the above case, when determining that the change in the condition of the parent (person) detected by the person's change detection section 307c is sudden change in expression and accordingly falls into “Sudden Change in Heartbeat or Expression” of the ID number “2”, the factor identification section 307d identifies the target with the first to third methods indicated in the item “Identification of Target” T43 of the ID number “2”. More specifically, the factor identification section 307d detects the person(s) by object detection and identifies the detected person (child) as the target with the first method. Further, the factor identification section 307d detects an object(s) other than persons by object detection and identifies the detected object other than persons as the target with the second method. If the person is identified as the target with the first method, and an object than persons is identified as the target with the second method, the target is finally identified according to the size of object. On the other hand, if the target cannot be identified with either of the first method and the second method, the factor identification section 307d identifies the surrounding environment as the target with the third method.

Then, the factor identification section 307d retrospectively identifies the point of time (e.g. a timing of a fall) at which the target (e.g. child) identified by the methods starts the significant change. If, for example, the person is identified as the target by the first method and an object other than persons is identified as the target by the second method as described above, the factor identification section 307d first takes a larger object as the target, and retrospectively identifies the point of time at which the target starts the significant change, and when being unable to identify the point of time, takes a smaller object as the target, and retrospectively identifies the point of time at which the target starts the significant change.

The editing section 307e edits the video in terms of time according to an identification result by the factor identification section 307d.

More specifically, the editing section 307e determines whether there is the significant change in the target identified by the factor identification section 307d.

When determining that there is no significant change in the target identified by the factor identification section 307d, the editing section 307e identifies the edit content “Reproduce video in normal time-series mode” with the edit content table 307b, and performs reproduction in the normal time-series mode (editing) on the predetermined number of frame images based on which the determination has been made.

On the other hand, when determining that there is a significant change in the target identified by the factor identification section 307d, the editing section 307e further determines whether the change amount per unit time of the change is at least a second predetermined threshold value that is for determining the size of the significant change.

When determining that the change amount per unit time of the change is less than the second predetermined threshold value, namely, small, the editing section 307e determines expression of the person (person detected by the person's change detection section 307c) at the point of time identified by the factor identification section 307d, identifies the edit content for the expression, and performs editing on the basis of the identified edit content. More specifically, when determining that the expression of the person at the point of time identified by the factor identification section 307d is neutral (e.g. surprised), the editing section 307e identifies the edit content “Divide screen into two windows, and reproduce video in both windows simultaneously while displaying target A (person detected by the person's change detection section 307c; the same applies hereinafter) in one window and target B (target identified by the factor identification section 307d; the same applies hereinafter) in the other window” with reference to the edit content table 307b, and performs editing with the edit content. When determining that the expression of the person at the point of time identified by the factor identification section 307d is negative (e.g. sad, scary or angry), the editing section 307e identifies the edit content “Reproduce video while paying attention to target B and displaying target A in small window” with reference to the edit content table 307b, and performs editing with the edit content. When determining that the expression of the person at the point of time identified by the factor identification section 307d is positive (e.g. happy, fond or at ease), the editing section 307e identifies the edit content “Reproduce video while sliding from target B to target A” with reference to the edit content table 307b, and performs editing with the edit content.

When determining that the change amount per unit time of the change is at least the second predetermined threshold value, namely, large, too, the editing section 307e determines expression of the person at the point of time identified by the factor identification section 307d, and performs editing according to the expression. More specifically, when determining that the expression of the person at the point of time identified by the factor identification section 307d is neutral, the editing section 307e identifies the edit content “Rewind video after reproducing video while paying attention to target A, and reproduce video again while paying attention to target B” with reference to the edit content table 307b, and performs editing with the edit content. For example, in the above case, when determining that the expression of the person (parent) at the point of time identified by the factor identification section 307d is surprised (neutral), the editing section 307e identifies the edit content “Rewind video after reproducing video while paying attention to parent (target A), and reproduce video again while paying attention to child (target B)” with reference to the edit content table 307b, and performs editing with the edit content. When determining that the expression of the person at the point of time identified by the factor identification section 307d is negative, the editing section 307e identifies the edit content “Reproduce video at low speed or high speed while switching target A and target B” with reference to the edit content table 307b, and performs editing with the edit content. When determining that the expression of the person at the point of time identified by the factor identification section 307d is positive, the editing section 307e identifies the edit content “Reproduce video with angle of view converted such that both target A and target B are in it (e.g. panorama editing or little planet editing (360° panorama editing))” with reference to the edit content table 307b, and performs editing with the edit content.

The abovementioned expressions of a person(s), namely, neutral (e.g. surprised), negative (e.g. sad, scary or angry) and positive (e.g. happy, fond or at ease), can be determined by any known voice analysis technique.

### <Video Editing>

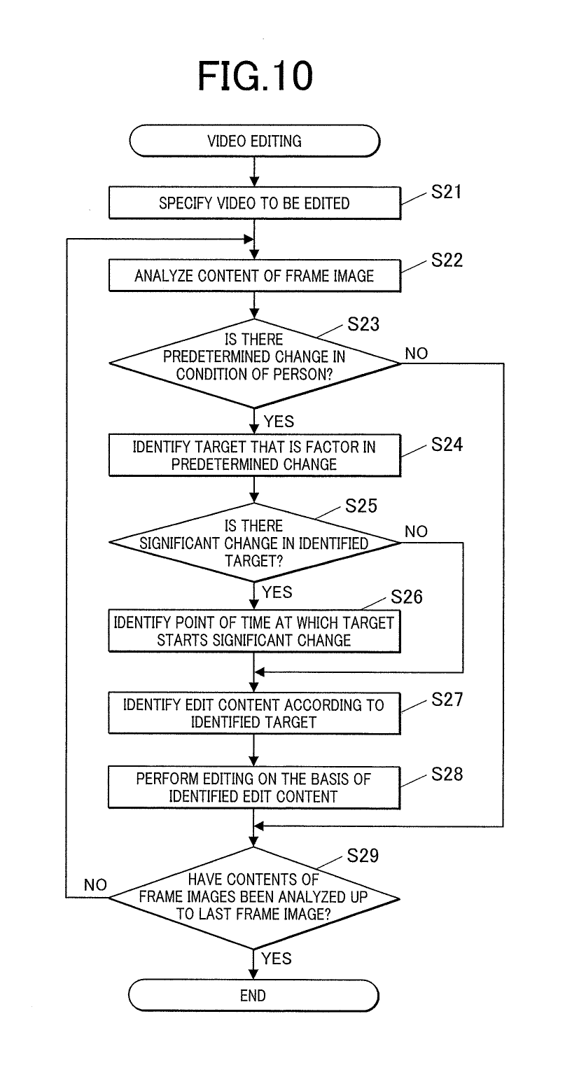

Next, video editing that is performed by the video processing apparatus 300 is described with reference to FIG. 10. FIG. 10 is a flowchart showing examples of actions of the video editing.

As shown in FIG. 10, first, when, on the basis of a user operation, a specifying operation is performed to specify an editing video from videos stored in the storage 103, and a command of the specifying operation is input from the operation inputter 105 to the video processor 307 (Step S21), the video processor 307 reads the specified video from the storage 103, and the person's change detection section 307c performs object detection, analysis of the condition of the person(s) (e.g. line-of-sight analysis, heartbeat analysis, expression analysis, etc.) and analysis of the characteristic amount(s) (estimation of the region(s) of interest) on the frame image of the read video as analysis of content of the frame image so as to detect, from the read video, change in the condition of the person recorded in the video (Step S22).

Next, when the person's change detection section 307c detects change in the condition of the person recorded in the video, the factor identification section 307d determines, with the factor identification table 307a, whether there is the predetermined change in the condition of the detected person, namely, whether the change in the condition of the person falls into one of “Sudden Change in Line of Sight” of the ID number “1” and “Sudden Change in Heartbeat or Expression” of the ID number “2” (Step S23).

When determining that there is no predetermined change in the condition of the detected person, namely, that the change in the condition of the person does not fall into either of “Sudden Change in Line of Sight” of the ID number “1” and “Sudden Change in Heartbeat or Expression” of the ID number “2” (Step S23; NO), the factor identification section 307d advances the process to Step S29.

On the other hand, when determining that there is the predetermined change in the condition of the detected person, namely, determining that the change in the condition of the person falls into one of “Sudden Change in Line of Sight” of the ID number “1” and “Sudden Change in Heartbeat or Expression” of the ID number “2” (Step S23; YES), the factor identification section 307d identifies the target that is the factor in the predetermined change by the target identification method(s) indicated in the item “Identification of Target” T43 of the ID number into which the change in the condition of the person falls (Step S24).

Next, the factor identification section 307d determines whether there is the significant change in the target identified in Step S24 by tracing the target back in the video in terms of time (Step S25).

When determining that there is no significant change in the target (Step S25; NO), the factor identification section 307d skips Step S26 and advances the process to Step S27.

On the other hand, when determining that there is the significant change in the target (Step S25; YES), the factor identification section 307d identifies the point of time at which the target starts the significant change (Step S26), and then advances the process to Step S27.

Next, the editing section 307e identifies, with the edit content table 307b, the edit content according to the target identified by the factor identification section 307d (Step S27). Then, the editing section 307e performs editing on the basis of the edit content identified in Step S27 (Step S28).

Next, the video processor 307 determines whether the person's change detection section 307c has analyzed contents of the frame images of the video up to the last frame image (Step S29).

When determining that the person's change detection section 307c has not analyzed contents of the frame images of the video up to the last frame image yet (Step S29; NO), the video processor 307 returns the process to Step S22 to repeat the step and the following steps.

On the other hand, when determining that the person's change detection section 307c has analyzed contents of the frame images of the video up to the last frame image (Step S29; YES), the video processor 307 ends the video editing.

As described above, the video processing apparatus 300 of this embodiment detects, from the video to be edited, change in the condition of the person recorded in the video, and when detecting the predetermined change in the condition of the person, edits the video in terms of time according to the factor in the predetermined change in the video. Alternatively, the video processing apparatus 300 of this embodiment, when detecting the predetermined change in the condition of the person, identifies the factor in the predetermined change in the video, and edits the video in terms of time according to the identification result.

This makes it possible, when detecting the predetermined change in the condition of the person recorded in the video to be edited, to perform editing in relation to the factor in the predetermined change in editing the video. Thus, this can edit the video(s) effectively.

Further, the video processing apparatus 300 of this embodiment identifies the target which is the factor in the predetermined change in the video when detecting the predetermined change in the condition of the person, identifies the point of time of the factor in the predetermined change in the video based on the identified target, and edits the video in terms of time according to the identified point of time. This can edit the video(s) more effectively.

Further, the video processing apparatus 300 of this embodiment detects change in the condition of the identified target in the video, and identifies the point of time at which the predetermined change in the target is detected as the point of time of the factor in the predetermined change in the video. This can identify the point of time of the factor in the predetermined change in the video with high accuracy.

Further, the video processing apparatus 300 of this embodiment, based on at least one of the state of the characteristic amount and line of sight of the person in the frame image in which the predetermined change in the condition of the person has been detected, identifies the target which is the factor in the predetermined change in the video when detecting the predetermined change in the condition of the person. This can identify the target that is the factor in the predetermined change in the video with high accuracy.

Further, the video processing apparatus 300 of this embodiment identifies the factor in the predetermined change in the video by selecting the method for identifying the factor in the predetermined change from methods correlated with respective types of the predetermined change in advance. This can properly identify the factor in the predetermined change according to the type of the predetermined change.

Further, the video processing apparatus 300 of this embodiment edits the video in terms of time according to at least one of the type and the size of the detected predetermined change in the condition of the person. This can edit the video(s) even more effectively.

Further, the video processing apparatus 300 of this embodiment edits the video in terms of time according to the type of the detected predetermined change in the condition of the target in the video. This can edit the video(s) even more effectively.

The present invention is not limited to the embodiments, and can be modified or changed in design in a variety of aspects without departing from the spirit of the present invention.

In the first to third embodiments, as the video to be processed by the video processor, the full 360-degree video is described as an example. However, the video may be the video that is taken in an ordinary way.

Further, the video processor 207 in the second embodiment may include the edit content table and the editing section that are the same as those in the first embodiment, and the editing section may edit the video (the editing video) according to change in the association element in the video, the association element being identified by the association element identification section 207d.

It is a matter of course that a video processing apparatus with components to realize the functions of the present invention pre-installed can be provided as the video processing apparatus of the present invention. Further, an existing information processing apparatus or the like can be made to function as the video processing apparatus of the present invention by application of programs. That is, the existing information processing apparatus or the like can be made to function as the video processing apparatus of the present invention by application of the programs to realize the functional components of the video processing apparatus 100, 200 and/or 300, which are described in the embodiments, such that a CPU or the like which controls the existing information processing apparatus can execute the programs.

Further, any method can be used for application of the programs. The programs may be applied by being stored in a computer readable storage medium, such as a flexible disk, a CD (Compact Disc)-ROM, a DVD (Digital Versatile Disc)-ROM or a memory card. Further, the programs may be applied via a communication medium, such as the Internet, by being superimposed on a carrier wave. For example, the programs may be distributed by being placed on a bulletin board (BBS: Bulletin Board System) on a communication network. Then, the programs may be started and executed under the control of an OS (Operating System) in the same manner as other application programs, so that the above processes can be performed.

In the above, several embodiments of the present invention are described. However, the scope of the present invention is not limited thereto. The scope of the present invention includes the scope of claims below and the scope of their equivalents.

What is claimed is:

1. A video processing apparatus comprising:
a target-of-interest identification section that identifies, from a video, targets of interest which are contained in the video, wherein at least one of the targets of interest is a person; and
a processing section that performs a predetermined process according to an association element that associates the targets of interest in the video with one another, the targets of interest being identified by the target-of-interest identification section.

2. The video processing apparatus according to claim 1, further comprising an association element identification section that identifies, in the video, the association element that associates the targets of interest with one another, the targets of interest being identified by the target-of-interest identification section, wherein
the processing section performs the predetermined process according to the association element identified by the association element identification section.

3. The video processing apparatus according to claim 2, wherein
the association element identification section identifies, in the video, the association element that associates the targets of interest with one another and changes with time, the targets of interest being identified by the target-of-interest identification section, and
the processing section performs the predetermined process according to a change with time in the association element in the video, the association element being identified by the association element identification section.

4. The video processing apparatus according to claim 2, further comprising an element-of-interest identification section that identifies elements of interest of the respective targets of interest identified by the target-of-interest identification section, each of the elements of interest changing with time in the video, wherein
based on the elements of interest of the respective targets of interest, the elements of interest being identified by the element-of-interest identification section, the association element identification section identifies, in the video, the association element that associates the targets of interest with one another.

5. The video processing apparatus according to claim 2, wherein
the video is constituted of images to be edited, and
the processing section edits the video according to a change with time in the association element in the video, the association element being identified by the association element identification section, thereby performing the predetermined process.

6. The video processing apparatus according to claim 2, further comprising a determination section that determines a change amount with time of the association element in the video, the association element being identified by the association element identification section, wherein
the processing section edits the video according to a result of the determination by the determination section, thereby performing the predetermined process.

7. The video processing apparatus according to claim 1, wherein the video is constituted of images successively taken by an imager.

8. The video processing apparatus according to claim 1, wherein the target-of-interest identification section identifies the targets of interest based on at least two of object detection, analysis of a condition of the person, and analysis of a characteristic amount in the video.

9. The video processing apparatus according to claim 2, wherein the association element identification section identifies at least one of a heartbeat, an expression, a behavior, and a line of sight of the person as the association element.

10. A video processing apparatus comprising:
a person's change detection section that detects, from a video to be edited, a change in a condition of a person recorded in the video; and
an editing section that, when the person's change detection section detects a predetermined change in the condition of the person, edits the video in terms of time according to a factor in the predetermined change in the video.

11. The video processing apparatus according to claim 10, further comprising an identification section that, when the person's change detection section detects the predetermined change in the condition of the person, identifies the factor in the predetermined change in the video, wherein
the editing section edits the video in terms of time according to a result of the identification by the identification section.

12. The video processing apparatus according to claim 11, wherein
the identification section includes:
a target identification section that identifies a target which is the factor in the predetermined change in the video when the person's change detection section detects the predetermined change in the condition of the person; and
a point-of-time identification section that identifies a point of time of the factor in the predetermined change in the video based on the target identified by the target identification section, and
the editing section edits the video in terms of time according to the point of time identified by the point-of-time identification section.

13. The video processing apparatus according to claim 12, wherein
the identification section further includes a target's change detection section that detects a change in a condition of the target in the video, the target being identified by the target identification section, and
the point-of-time identification section identifies a point of time at which the target's change detection section detects a predetermined change in the target as the point of time of the factor in the predetermined change in the video.

14. The video processing apparatus according to claim 12, wherein based on at least one of a state of a characteristic amount and a line of sight of the person in a same frame image of the video, the target identification section identifies the target which is the factor in the predetermined change in the video when the person's change detection section detects the predetermined change in the condition of the person.

15. The video processing apparatus according to claim 11, wherein the identification section identifies the factor in the predetermined change in the video by selecting a method for identifying the factor in the predetermined change from methods correlated with respective types of the predetermined change in advance.

16. The video processing apparatus according to claim 10, wherein the editing section edits the video in terms of time according to at least one of a type and a size of the predetermined change in the condition of the person, the predetermined change being detected by the person's change detection section.

17. The video processing apparatus according to claim 13, wherein the editing section edits the video in terms of time according to a type of the predetermined change in the condition of the target in the video, the predetermined change being detected by the target's change detection section.

18. A video processing method comprising:
identifying, from a video, targets of interest which are contained in the video, wherein at least one of the targets of interest is a person; and
performing a predetermined process according to an association element that associates the targets of interest in the video with one another, the targets of interest being identified in the identifying.

19. A video processing method comprising:
detecting, from a video to be edited, a change in a condition of a person recorded in the video; and
when, in the detecting, detecting a predetermined change in the condition of the person, editing the video in terms of time according to a factor in the predetermined change in the video.

20. Anon-transitory computer readable storage medium storing a program that causes a computer to realize:
a target-of-interest identification function that identifies, from a video, targets of interest which are contained in the video, wherein at least one of the targets of interest is a person; and
a processing function that performs a predetermined process according to an association element that associates the targets of interest in the video with one another, the targets of interest being identified by the target-of-interest identification function.

21. A non-transitory computer readable storage medium storing a program that causes a computer to realize:
a person's change detection function that detects, from a video to be edited, a change in a condition of a person recorded in the video; and
an editing function that, when the person's change detection function detects a predetermined change in the condition of the person, edits the video in terms of time according to a factor in the predetermined change in the video.
